(19) United States
(12) Patent Application Publication
(10) Pub. No.: US 2007/0016789 A1
(43) Pub. Date: Jan. 18, 2007

(54) Methods and systems for signing physical documents and for authenticating signatures on physical documents

(76) Inventors: Jelle Wiersma, Drachtster (NL); Hendrik Cornelis Fijnvandraat, Enschede (NL)

Correspondence Address: PERMAN & GREEN, 425 POST ROAD, FAIRFIELD, CT, 06824, US

(21) Appl. No.: 11/485,705

(22) Filed: Jul. 13, 2006

(30) Foreign Application Priority Data
Jul. 13, 2005 (EP) 05076611.2

(51) Int. Cl. H04L 9/00

(52) U.S. Cl. 713/176

(57) ABSTRACT

In a method for providing physical documents with a signature, a document code is derived from at least a part of a content of the physical document. A signature code is derived at least from the document code and from an identification code of a signing party. The physical document is provided with a signature marking representing the signature code. Optionally, the physical document is provided with a document marking representing the document code. A signature provided on a physical document may be authenticated. During authentication, a signature marking provided on the physical document is detected. The signature marking represents a signature code. Then, the signature code is derived from the detected signature marking. Content data representing at least a part of the content of the physical document is received and a first document code is derived from the content data. Then, a relationship between the signature code, an identification code of a signing party and the first document code is determined. The signature is validated in case the relationship satisfies a validation criterion.

### FIELD AND BACKGROUND OF THE INVENTION

The invention relates to a method and system for signing physical documents. The invention further relates to a method and system for authenticating signatures on physical documents. The invention also relates to a method for sending physical documents. The invention further relates to a computer program product. The invention also relates to a physical document provided with a signature.

It is known to provide a signature on a physical document is used, inter alia, to verify the origin of the physical document. To perform this function, the signature is provided on the physical document by a signing party as a handwritten mark which is unique for the signing party. Another function of the signature is to verify that the physical document is authentic. Especially for legal documents, such as contracts or wills, the signature is also used as a means of authentication of the document itself. The signature further forms a means to verily that the intentions of the signing party are expressed in the legal document. Often, the signature is provided on the first page or last page of the physical document.

However, unless all pages of a physical document are signed, it cannot be ascertained with complete certainty that a received physical document is indeed the same as the physical document signed by a sending party. Even if all pages are signed, without additional investigations, it cannot be ascertained that parts of the physical document have not been tampered with. E.g. pages could be missing or phrases of text have been modified without affecting the signature.

Hence, the known manner of signing physical documents is sensitive to fraud.

### SUMMARY OF THE INVENTION

It is a goal of the invention to provide a method and a system for signing physical documents which is more fraud-proof.

Therefore according to an aspect of the invention a method for providing physical documents with a signature is provided, which includes:

deriving a document code from at least a part of a content of the physical document;

deriving a signature code at least from the document code and from an identification code of a signing party;

providing the physical document with a signature marking representing the signature code; and

optionally providing the physical document with a document marking representing the document code.

Such a method is more fraud proof, because in case the document has been tampered with, for instance by modifying parts of the document content, the signature code will no longer match with the document. Accordingly, it can be ascertained that the physical document is the physical document signed by the signing party.

According to another aspect of the invention, a method for authenticating a signature is provided, which includes:

detecting a signature marking provided on the physical document, which signature marking represents a signature code;

deriving the signature code from the detected signature marking;

deriving a first document code from content data derived from the physical document; and

determining a relationship between the signature code, an identification code of a signing party and the first document code and validating the signature in case said relationship satisfies a validation criterion.

Such a method enables a fraud-proof authentication of the signature, since in case the document content has been tampered with or the signature has been modified, the relationship between the signature code, the content and identification code will be different. The relationship will then fail to satisfy the validation criterion and the signature will not be validated.

According to yet another aspect of the invention a method for sending physical documents is provided, in which physical documents are provided with a signature by applying the method therefor described above and the signature is authenticated by applying the method therefor described above.

According to further aspects of the invention, a system for signing physical documents is provided which includes:

an input for receiving a document content of the physical document;

a processor in contact with the input, for deriving a document code from at least a part of the document content, and deriving a signature code from the document code and an identification code of a signing party; and

an output for providing a signature marking representing the signature code on the physical document.

The invention further provides for a system for authenticating signatures, which includes:

a detector for detecting a signature marking provided on the physical document, which signature marking represents a signature code;

a processor connected to the detector, which processor includes a first input for receiving data representing at least a part of the content of the physical document and a second input for receiving data representing an identification code of a signing party, and which processor is arranged for:

deriving a document code from the content of the physical document; and

determining a relationship between the signature code, the identification code and the document code and outputting a validation signal in case said relationship satisfies a validation criterion.

According to a further aspect of the invention, a computer program product for carrying out the above described method for providing physical documents with a signature is provided. The invention may also be embodied in a physical document provided with a signature marking representing a signature code, which signature code is derivable from at least a part of the content of the physic at document and from an identification code specific for a signing party.

### BRIEF DESCRIPTION OF THE DRAWINGS

Further details, aspects and embodiments of the invention will be described, by way of example only, with reference to the drawings.

FIG. 1 shows a flow-chart of an example of a method for signing a physical document according to the invention.

FIG. 2 shows a flow-chart of an example of a method for authenticating a signature according to the invention.

FIG. 3 schematically shows block diagrams of examples of embodiments of a system for signing physical documents and a system for authenticating signatures.

FIG. 4 schematically shows a signed document.

### DETAILED DESCRIPTION

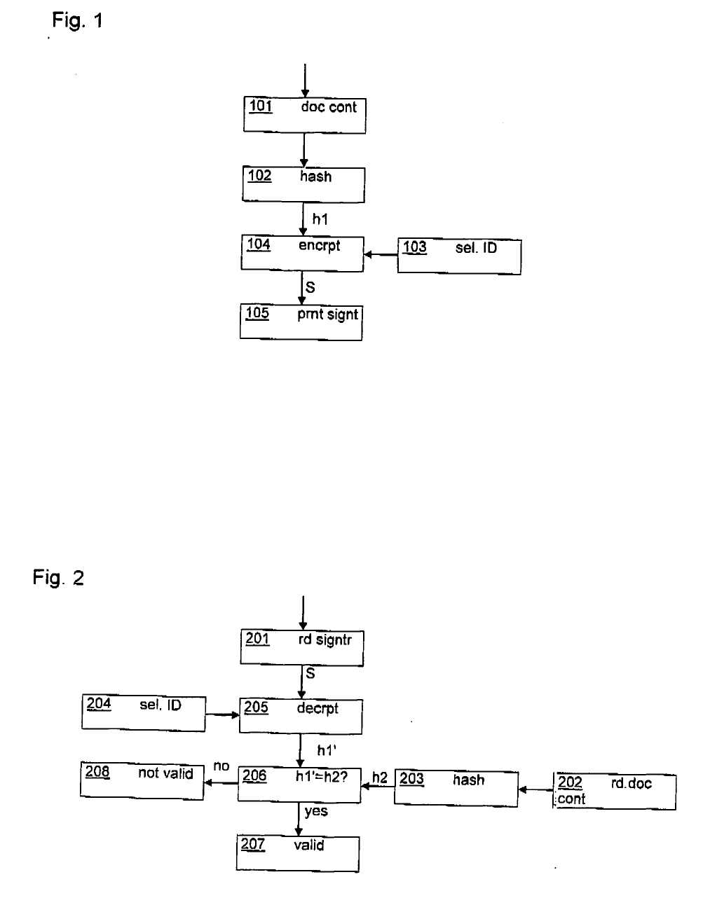

FIG. 1 schematically shows a flow-chart of an example of a method for providing a signature. The method is initiated with receiving in a first signing step 101 a document content of the physical document to be signed. For example, a data file may be received which contains data representing the document content and optionally data defining the appearance of the document.

In a second signing step 102, a document code is derived from it least a part of the content of the physical document. For example, a hash code h1 may be determined from the data in the received data file. A hash code, also referred to as a hash value, is computed from input data using some hashing algorithm. In a mathematical sense, a hash algorithm H projects a value from a set with many members to a value from a set with fewer members. In second signing step 102, for example, a Message Digest 5 (MD5) algorithm or a Secure Hash Algorithm (SHA) may be used

After the document code is derived, a fourth signing step 104 it performed. In the third signing step, a signature code S is derived from the document code and from an identification code of a signing party. In this example, the identification code ID is selected by the signing party in third signing step 103. In a fifth signing step 105, the signature code S is then providing on the physical document in the form of a signature marking which represents the signature code. Optionally, the physical document may also be provided with a document marking representing the document code h1.

After performing a method for providing a signature, such as illustrated in FIG. 1 for example, the physical document can be sent to an addressee. After the physical document has been received by the addressee, a method can be performed to authenticate the physical document.

The flow-chart of FIG. 2 schematically illustrates a method for authenticating a signature provided on a physical document. The method is started with a first authentication step 201. In first authentication step 201 a signature marking is detected on a physical document. The signature marking represents a signature code S. In the first authentication step 201, the signature code S is derived from the detected signature marking. For example, the signature marking may be provided on the physical document in the form of a barcode. In such case, in the first authentication step 201, the physical document 5 may be received and scanned by means of a barcode scanner. The barcode data from the barcode scanner then represent the signature code S.

In a second authentication step 202, content data representing a document content of the physical document 5 are determined from the physical documents. For example, the pages of the physical document 5 may be scanned by an optical scanner 4, and the scan data from this scanning may be processed with an optical character recognition program, yielding data representing the content of the physical document 5.

In third authentication step 203, a first document code h2 is derived from the document content. The first document code h2 may for example be derived in a manner similar to that of the second signing step 102. In the example of FIG. 2, the first document code h2 is for instance derived by means of a hash operation resulting in a hash code.

In a fourth authentication step 204, an identification code ID of the signing party is selected.

In fifth and sixth authentication steps 205,206 a relationship between the signature code S, the identification code ID and the first document code is determined. The signature is validated in a seventh validation step 207 in case the relationship satisfies a validation criterion. When the relationship fails to satisfy the validation criterion, the signature is marked as not valid in a eighth validation step 208. Thus, when the document content has been tampered with, e.g. certain phrases have been removed or added, the relationship between the signature code S, the identification code ID and the first document code h2 will change and the signature will not be validated.

For example, in the fifth authentication step 205, a second document code h1′ may be derived from the signature code S and the identification code ID. For instance, the signature code S may be an encrypted code which can be decrypted using the identification code ID as a key. The resulting decrypted code may then be the second document code h1′. In sixth authentication step 206, the first document code h2 may be compared with the second document code h1′ and the signature may be validated in case the first document code h2 matches the second document code h1′.

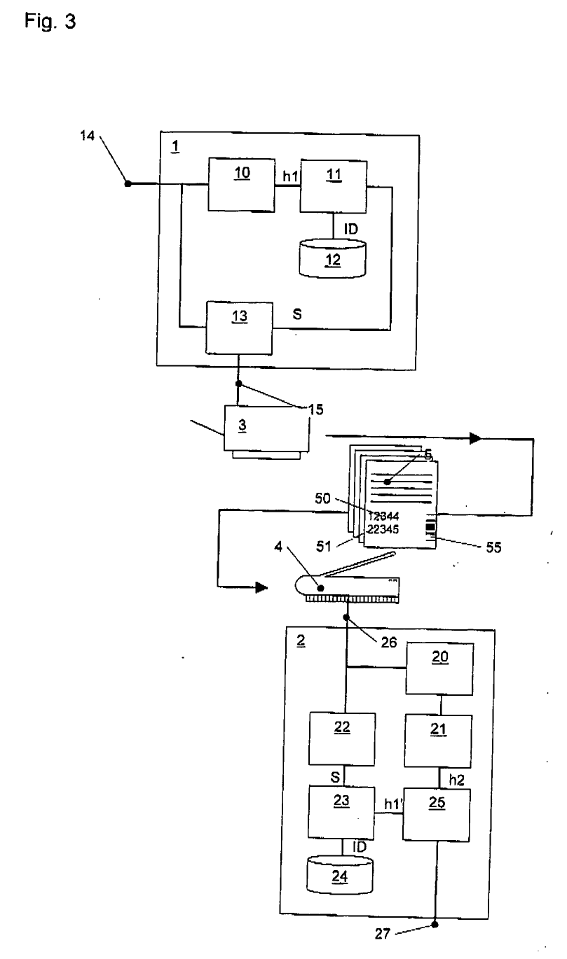

FIG. 3 schematically illustrates a system for signing a physical document. The system includes a signing system input 14 for receiving content data representing at least a document content of the physical document. The content data may for example be received as an ASCII file defining the text of the physical document. However, the content data may also represent further aspects of the physical document. The content data may for example define a content of a document and a make-up or lay-out of the document. In such case, the content data may for example be received as a Printer Command Language (PCL) file, a personalized printer mark-up language (PPML) file, a Postscript file, a PDF (Portable document format) file or any other suitable type of file.

The content data may be used in processing of a document and for instance be readable by a printer 3, as shown in FIG. 3. After the content data has been received by the printer 3, the printer 3 may then print a physical document which has the content and make-up defined by the content data.

The signing system input 14 is connected to a processor 1. The processor 1 is arranged to derive a signature code S from the document content and an identification code ID of a signing party. The processor 1 is connected with an output 15 to the printer 3. Via the output 15, a signature marking representing the signature code S can be outputted to a printer 3 and printed on a physical document.

In the example of FIG. 3, the processor 1 includes a hash unit 10 connected to the system input 14. The hash unit 10 can receive the content data and derive from the document content a document code h1. In this example, for instance, the document code h1 is derived by performing a hash operation on the content data. An output of the hash unit 10 is connected to an input of an encryption unit 11. Via the output the document code h1 can be transmitted to the encryption unit 11.

The encryption unit 11 can receive the document code h1 from the hash unit 10 at an input. Another input of the encryption unit 11 is connected to a memory 12 in which one or more identification codes are stored. In this example, the encryption unit 11 retrieves an identification code ID of the signing party from the memory 12. The signing parties identification code ID may for instance be selected automatically based on an identifier of a user of the system 1. For example in case the system is implemented on a programmable apparatus, the identification code ID may be selected depending on the login identification of a user of the programmable apparatus. However it is also possible that, the system is arranged to receive an identification code inputted manually by a signing party, for example at a man-machine interface of the system.

The encryption unit 11 derives a signature code S from the document code h1 and the identification code ID. In this example, for instance, the encryption unit 11 is arranged to encrypt the document code h1 with an encryption algorithm, which uses the identification code ID. Thus, the resulting signature code S is an encrypted code which depends both on the document code h1 and the identification code ID.

In this example, the encryption unit 11 is connected with an output to a marking unit 13 which generates a signature marking which represents the signature code S. For example, the marking unit 13 may receive the signature code S and generate barcode data defining a barcode which represent the signature code S. In this example, the marking unit 13 is further connected to the system input 14. The marking unit 13 receives via the system input 14 the content data and modifies the content data by adding to the content data marking data which represents the signature marking 50.

The modified content data can be outputted by the marking unit 13 to a printer 3 via the system output 15. The printer 3 can print a physical document 5 in accordance with the data file. Since the data file includes the marking data, the printed physical document is provided with the signature marking 50. Depending on the specific implementation, the marking unit 13 may also add marking data representing other markings to the data files. For example, the marking unit 13 may add content marking data which defines a content marking 51 representing the document code or encryption marking data which defines an encryption marking containing information about the encryption scheme or any other suitable marking.

As shown in FIG. 3, the physical document 5 provided with the signature marking 50, and optional additional markings 51, may be sent to an addressee. After being received by the addressee, the physical document 5 may be processed by a system for authenticating signatures in order to verify that the received document is the document signed by the signing party and to verify that the document content has not been tampered with.

FIG. 3 further shows an example of a system for authenticating signatures. The systems includes a content data generator, which in this example includes a scanner 4 connected to an authentication processor input 26 of an authentication processor 2. The scanner 4 optically scans the physical document and obtains one or more images of the physical document 5. Data representing the images is presented by the scanner 4 at the input 26.

In the example of FIG. 3, the authentication processor 2 includes an image processing unit 20. The image processing unit 20 is connected to the authentication processor input 26. The image processing unit 20 is arranged to perform an optical character recognition (OCR) operation. In the OCR operation, the content, e.g. text, of the physical document is determined from the images. It should be noted that OCR is generally known in the art of image processing, and for the sake of brevity is not described in further detail. Thus, the content of a physical document 5 can be derived by the scanner 4 and the image processing unit 20. In the examples, a two or more OCR operations may be performed simultaneously and the results of the OCR operations may be compared, in order to reduces the chance of errors in the OCR. The partial results of the OCR operations may be compared, i.e. after having processed a part of the physical document, thus allowing an identification of the specific part of the physical document in which the OCR error has occured. Optionally, the specific part in which the error occurred may be rescanned thereafter.

Connected to an output of the image processing unit 20 is a hash unit 21. The hash unit 21 can receive the content data from the processing unit 20 and derive from the document content, a first document code h2. In this example, for instance, the document code h2 is derived by performing a hash operation on the content data. An output of the hash unit 21 is connected to an input of a comparator unit 25. At the output of the hash unit 21, the document code h2 can be presented.

A marking detector 22 is connected to the input 26. The marking detector 21 can detect a signature marking 60 in the images. The signature marking 50 may for example include a barcode marking. The marking detector 22 may then be arranged to detect a barcode in the images, and to derive data from the detected barcode marking can be determined. It should be noted that detection of barcodes is generally known in the art of image processing, and for the sake of brevity the process of detecting the signature marking and deriving the signature code from the signature marking is not described in further detail. However, the invention is not limited to signature markings formed by barcodes and other suitable markings may also be used. For instance, the signature marking may be provided on the document as (a sequence of) an alphanumeric signs, and the marking detector may be arranged to detect and recognise alphanumeric signs. The marking detector 22 further derives from the detect signature marking 50 a signature code S and outputs data representing the signature code S to a decryption unit 23.

The decryption unit 23 can derive a second document code h1′ from the signature code S and from an identification code ID of a signing party stored in a memory 24. In this example for instance, the decryption unit 23 can perform a decryption operation which is substantially the reverse of the encryption operation performed by the encryption unit 11. In this example, the signature code S was obtained from an encryption operation involving the document code h1 and the identification code ID. The result of decrypting the detected signature code S is a second document code h1′. The second document code h1′ can be transmitted via an output of the decryption unit 23 to an input of the comparator unit 25.

The comparator unit 25 is arranged to compare the first document code h2 with the second document code h1′ and to output a validation signal at an authentication system output 27 when this comparison satisfies a validation criterion. Together with the comparator unit 25, the decryption unit 23 is thus able to determine a relationship between the signature code S, the identification code ID of a signing party and the document code and to validate the signature in case said relationship satisfies a validation criterion.

The comparator unit 25 may be implemented with any validation criterion suitable for the specific implementation. In the example of FIG. 3, the comparator unit 25 outputs a validation signal if and only if the first document code and the second document code are sufficiently similar. (I.e. in case the difference between the first document code and the second document code satisfies a validation requirement).

For example, the comparator unit may output the validation signal in case the difference between the first document code h2 and the second document code h1′ is below a certain threshold. For instance in the example of FIG. 3, the comparator unit 25 outputs a validation signal only when the first document code h2 and the second document code h1′ are exactly the same, i.e. the threshold is zero.

However, the threshold may also be larger than zero. In such case, the requirements with respect to obtaining the document content from the physical document may be lessened. Errors in the derived document content might result in a first document code h2 which differs from the second document code h1′. Accordingly, allowing a difference between the first document code h2 and the second document code h1′ obviates the required accuracy level.

In a method or system according to the invention, the signature code may be derived in any suitable manner from the document code and the identification code of a signing part. For example, the signature code may be derived by encoding with an encryption algorithm which involves both the document code and the identification code. For example, the document code may be encrypted with a encryption scheme which uses the identification code as an encryption key.

The encryption scheme may for example be a symmetric encryption scheme

For example, in symmetric-key encryption, the same (secret) key is used both to decrypt and encrypt a packet of information. The identification code of the signing party may then be the key used to encrypt and decrypt the encrypted signature code. The identification code may, e.g. be known only to the signing party and be provided to the receiving party of the physical document via a separate route. The addressee of the physical document and the physical document may be provided with a marking representing an identification of the signing party, e.g. its name. A receiving party of the physical document may then look-up the key used by that party and decrypt the signature code, in order to obtain the document code. The symmetric-key scheme may for instance be a DES (Data Encryption Standard) encryption scheme, as for example specified in the ANSI (American National Standards Institute) X3.92 and X3.106 standards. Symmetric key encryption algorithms are generally known in the art of secure data transmission and for the sake of brevity not described in any further detail.

The encryption scheme may also be a public-key encryption scheme. Public-key encryption uses a combination of a private key and a public key. In the examples of methods or systems for signing a physical document, the private key may be known only to the signing party, while the public key is publicly available, and may e.g. be printed on the physical document. In the example, the private key may be used to encrypt the document code, resulting in the signature code. The private key may for example be the private key of a signing party. Thereafter, the signature code is provided on the physical document as a signature marking, for example by printing alphanumeric signs representing the signature code on the physical document. A party receiving the physical document may then read the signature code and decrypt the signature code with a decrypting algorithm corresponding to the used encryption algorithm. In the decryption, a public key (mathematically related to the used private key) is used. The suitable public key may for example be printed on the physical document or be provided via a trusted third party. Public key encryption algorithms are generally known in the art of secure data transmission and for the sake of brevity not described in any further detail. Examples of suitable public key encryption algorithms, are the RSA or PKI encryption algorithms. However, other types of public-key encryption algorithms may also be used.

In a method or system according to the invention, any identification code suitable for the specific implementation may be used. The identification codes used for signing and authentication may for instance be the same. In case the same identification code is used for signing and authentication, the identification code may be known to only the signing party and the addressee, in order to ensure that the signature marking is provided by the signing party, and not a fraud.

However, the identification codes used for signing and authentication may also be different. In such case, the identification code used for signing may be kept secret by the signing party, but information may be publicly available about the identification code used for authentication. For example, the identification code used for signing may be a private key of a public key encryption and the identification code used for authentication may be a public key corresponding to this private key.

The identification code used for authentication and/or signing may be unique for a signing party, i.e. there is no other signing party using the same identification code. Thereby, the possibility to commit fraud with a physical document is reduced further, since the only party which can provide the signature is the signing party. However, for instance, in case the identification code is known only to the signing party and the addressee, the identification code may be not unique or the signing party.

The document code generated from (a part of) the document content may be unique for the specific content of the physical content. Thus, if the content of a physical document has been tampered with, the document code determined from the content during authentication will always differ from the document code used to derive the signature code.

However, the document code may lack uniqueness. For example, a document code may be derived which could be the same for a number of document contents. For instance, in the example of FIGS. 1 and 2, a hash algorithm may be used in second signing step 102. The hash algorithm may for example be a one-way hash function. A one-way hash function is a hash function which maps an arbitrary length message M to a fixed length message digest or hash code MD via an operation MD=H(M), and given M and MD, it is hard, however not impossible, to find a message N different from message M such that H(N)=H(M). For example, there may be a small chance that two messages have the same hash code. This small chance may for example be lower than or equal to 10⁻⁶, such as lower than or equal to 10⁻⁹. However, the hash code may also be unique for the specific document content.

During signing of the physical document or authentication of the signature, the document code and/or document content may be derived in any manner suitable for the specific implementation. For example, print data may be received which represents a document content to be printed, and optionally represents definitions of the appearance of a document with this document content. The print data may for instance be readable by a printer 3, such that a printed document 5 contains the content represented by the print data (and, optionally, has the appearance defined by the print data). The document code may then be derived from at least a part of the received print data. For example, all the received print data may be used as input for a hash operation. Also, for example, only the part of the received data which represents the document content can be used. For instance, a print file may include commands representing the document content and commands representing the lay-out of the document to be printed. The commands representing the document content may then be used to determine the document code.

For example, using pseudo-code, a print file may contain the commands:

font: arial (defining the type of font)

font size: 11 pt (defining the size of the font)

text position: 11, 11 (defining the position on the page at which the text starts)

text: aaabbbbccc

In a system or method according to the invention, the print file may then be searched for commands of the type ‘text’ and the characters following the command may be used to the determine the content.

The signature marking may be provided on the physical document in any suitable manner. For example, the signature marking may be provided on the physical document when the physical document is printed. For example, marking print data may be generated from the signature code which defines the appearance of the signature marking, and which can be read by a printer. The marking print data may for example be added to the print data causing a physical document printed in accordance with the print data to have a marking in accordance with the marking print data.

However, the signature marking may also be provided before or after printing the physical document. For example, after printing the physical document, a separate signature printing operation may be performed. From the signature code, signature print data may be generated which can be read by a printer and defies the appearance of the signature marking. The signature print data may then be sent to a printer which print the signature marking onto the physical document.

The signature code may be derived from a single document code and from the identification code. For example, in case a single document code is derived from the entire document content. However, the signature code may also be derived from two or more document codes. For example, a first document code may be derived from a first part of the document content of the physical document. A second document code may be derived from a second part (different from the first part) of the document content of the physical document etc. Thereby, in addition to detecting modifications to the content of the physical document, also the specific part (e.g. the first or the second) which has been tampered with can be determined. The first part and the second part may for example be on different pages of the physical document or be different sections of a text, e.g. different clauses of a contract. The signature code may for instance be derived from at least two parts of the document content on different pages.

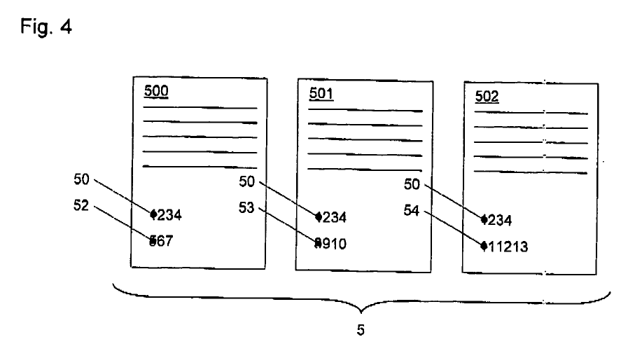

Furthermore, more than one signature marking may be provided to (different parts of) a physical document. For instance the example of FIG. 4, for each of a number of pages of a physical document a signature code has been derived from a document code determined from the content of a page and the identification code of the signing party. In FIG. 4, each sheet 500-602 of the physical document 5 has been provided with a signature marking 50 representing a signature code derived from the content of a number of pages, e.g. the whole document, and a page marking 52-54 representing a signature code derived from the content of a single page.

The signature code may further contain information about a data and/or time and/or place of signing the physical document. For example, the signature code may include a table with two or more codes derived from the identification code and respectively, the document code, a date code representing the date and a place code representing the place of signing the physical document. For example, the signature code may be derived by encrypting a character string with the identification code. For example, the string may include, in that order, a number of characters representing the document code, a number of characters representing the date and characters representing the place. The character string may then, for example, have a fixed length, and/or the different types of information may occupy a predetermined position in the string. Thereby, it can be determined in a simple manner which character in the string belongs to, e.g., the document code, the data code or the place code.

As mentioned, in addition to the signature marking, additional markings may also be provided. For example, when signing the physical document a document marking representing the document code may be provided on the physical document. The additional markings may include, an identification marking representing the identification code to be used in the authentication or an encryption marking representing information about the encryption process. During authentication, the document marking and/or identification marking provided on the physical document may then be detected, and the code represented by the marking determined. In case a document marking is provided, during authentication, a third document code may be derived from the document marking. The signature may then be deemed valid if and only if the third document code and/or the second document code anchor the first document code are sufficiently similar.

As shown in FIG. 3, for example, a barcode marking 55 may be provided on the physical document 5 representing the third document code, while the signature marking 50 is provided by means of alphanumeric signs on the physical document 5. From the barcode marking 55, the third document code may be derived, and, for example, be used to determined whether or not the determination of the first document code was correct. When the third document code differs from the first document code, the content of the physical document may be determined again. When the first and third document code are the same, the first document code may be compared with the second document code to detect any tampering with the physical document

In case the addition marking is an encryption marking, deriving a second document code h1′ during authentication of the signature may include deriving information about a suitable decrypting scheme from a marking on the physical document. Thereafter the signature code can be decrypted with a suitable decrypting scheme.

The invention may further be embodied in a physical document provided with a signature marking representing a signature code, which signature code is derivable from at least a part of the content of the physical document and from an identification code specific for a signing party. The physical document to be signed or to be authenticated may be any suitable physical document. The physical document may for instance be a legal document, such as a contract or a will. However, the physical document may also be of a different kind

The invention is not limited to implementation in the disclosed examples of devices, but can likewise be applied in other devices. In particular, the invention is not limited to physical devices or units implemented in non-programmable hardware but can also be applied in programmable devices or units able to perform the desired device functions by operating in accordance with suitable program code. Furthermore, the devices may be physically distributed over a number of apparatuses, while logically regarded as a single device. For example, the processor 1 of the system for signing physical documents shown in FIG. 3 may be physically implemented as a number of hardware devices arranged to perform the functions of the processor. Also, devices logically regarded as separate devices may be integrated in a single physical device. For example, the units 20-25 of the system shown in FIG. 3 can be implemented in a single processor able to perform the functions of the respective units.

The invention may also be implemented in a computer program for running on a computer system, at least including code portions for performing steps of a method according to the invention when rim on a programmable apparatus, such as a computer system or enabling a programmable apparatus to perform functions of a device according to the invention. Such a computer program may be tangible embodied in a data carrier, such as a CD-ROM or diskette, stored with data loadable in a memory of a computer system, the data representing the computer program or any other type of article of manufacture suitable for the specific implementation. The data carrier may further be a data connection, such as a telephone cable or a wireless connection transmitting signals representing a computer program according to the invention.

In the foregoing specification, the invention has been described with reference to specific examples of embodiments of the invention. However, various modifications and changes may be made. For example, the signature marking or other markings may be provided on the physical document in any manner suitable for the specific implementation, and may for example include 1D or 2D barcodes, alphanumeric signs or other suitable markings. The specifications and drawings are, accordingly, to be regarded in an illustrative rather than in a restrictive sense.

1. A method for providing physical documents with a signature, including:
deriving a document code from at least a part of a content of the physical document;
deriving a signature code at least from the document code and from an identification code of a signing party;
providing the physical document with a signature marking representing the signature code; and
optionally providing the physical document with a document marking representing the document code.

2. A method according to claim 1, wherein the document code is unique for the specific content of the physical content, and/or the identification code is unique for a specific signing party.

3. A method according to claim 1, wherein deriving the document code includes:
receiving print data representing at least a document content to be printed and deriving the document code from at least a part of the received print data;
and wherein providing the physical document with a signature marking representing the signature code and/or providing the physical document with a document marking representing the document code includes:
adding marking data to the print data, which marking data define the signature marking and/or the document marking; and
printing the physical document in accordance with the print data.

4. A method according to claim 1, including:
receiving print data representing at least a document content to be printed;
printing a physical document in accordance with the print data; and
providing the physical document after said printing with the signature marking and/or the document marking.

5. A method according to claim 3, wherein the signature code is derived from at least a first document code, a second document code and the identification code, and the method including:
deriving the first document code from a first part of the document content of the physical document, and deriving the second document code from a second part of the document content of the physical document, which second part is different from the first part.

6. A method according to claim 1, further including:
receiving the identification code via an interface or retrieving the identification code from a non-volatile memory.

7. A method according to claim 1, further including selecting the identification code, for example depending on a user and/or a processing instruction of the physical document.

8. A method according to claim 1, wherein the signature code is derived from at least two parts of the document content on different pages.

9. A method according to claim 1, wherein the signature code includes an encrypted code and wherein deriving the signature code includes:
obtaining the encrypted code by encrypting the document code with an encryption scheme, optionally said encrypting depending on at least the identification code; and optionally providing the physical document with a encryption marking, which encryption marking represents information about the encryption scheme.

10. A method according to claim 9, wherein the encryption scheme includes a public key encryption scheme, and the identification code includes a private key of the public key encryption scheme and, optionally, said method further including: providing a public key marking to the physical document representing a public key corresponding to the private key.

11. A method according to claim 1, wherein the signature code is at least partially derived from data representing a time and/or a place of signing the physical document.

12. A method for authenticating a signature provided on a physical document, including:
detecting a signature marking provided on the physical document, which signature marking represents a signature code;
deriving the signature code from the detected signature marking;
deriving a first document code from content data derived from the physical document; and
determining a relationship between the signature code, an identification code of a signing party and the first document code and validating the signature in case said relationship satisfies a validation criterion.

13. A method according to claim 12, including:
deriving a second document code from the signature code and the identification code;
in which method said determining a relationship includes comparing the first document code and the second document code; and
in which method the signature is validated if and only if the first document code and the second document code are sufficiently similar.

14. A method according to claim 13, further including:
detecting a document marking provided on the physical document, which document marking represents a third document code;
deriving the third document code from the document marking;
in which method said determining a relationship includes:
comparing the third document code with at least one of the first document code and the second document code; and
in which method the signature is validated if and only if the third document code is sufficiently similar to the second document code and/or the first document code.

15. A method according to claim 12, wherein the signature code includes an encrypted code and said deriving a second document code includes:
decrypting the encrypted code with a suitable decryption scheme, optionally selecting said decryption scheme depending on the identification code,
and, optionally, deriving information about a suitable decrypting scheme from a marking on the physical document.

16. A method according to claim 15, wherein said decrypting scheme is a public key decrypting scheme, wherein the identification code is a public key of said public key encryption scheme and, optionally, including deriving said public key from a marking on the physical document.

17. A method for sending physical documents, including:
deriving a document code form at least a part of a content of the physical document;
deriving a signature code at least from the document code and from an identification code of a signing party;
providing the physical document with a signature marking representing the signature code; and
optionally providing the physical document with a document marking representing the document code;
sending the physical document to an addressee;
receiving the physical document by the addressee;
detecting a signature marking provided on the physical document, which signature marking represents a signature code;
deriving the signature code from the detected signature marking;
deriving a first document code from content data derived from the physical document; and
determining a relationship between the signature code, an identification code of a signing party and the first document code and validating the signature in case said relationship satisfies a validation criterion.

18. A method according to claim 1, wherein the physical document is a legal document, such as a contract or a will.

19. A system for signing physical document including:
an input for receiving a document content of the physical document;
a processor in contact with the input, for deriving a document code from at least a part of the document content, and deriving a signature code from the document code and an identification code of a signing party; and
an output for providing a signature marking representing the signature code on the physical document.

20. A system for authenticating signatures, including:
a detector for detecting a signature marking provided on the physical document, which signature marking represents a signature code;
a processor connected to the detector, which processor includes a first input for receiving data representing at least a part of the content of the physical document and a second input for receiving data representing an identification code of a signing party, and which processor is arranged for:
deriving a document code from the content of the physical document; and determining a relationship between the signature code, the identification code and the document code and outputting a validation signal in case said relationship satisfies a validation criterion.

21. A computer program product including program code portions for performing a method as claimed in claim 1, when run on a programmable apparatus.

22. A physical document provided with a signature marking representing a signature code, which signature code is derivable from at least a part of the content of the physical document and from an identification code specific for a signing party.
